(19) United States
(12) Patent Application Publication
(10) Pub. No.: US 2007/0124282 A1
(43) Pub. Date: May 31, 2007

(54) Video data directory

(76) Inventor: Erland Wittkotter, Hayward, CA (US)

Correspondence Address: Erland Wittkotter;Apt 174, 25200 Carlos Bee Blvd, Hayward, CA, 94542, US

(21) Appl. No.: 11/286,774

(22) Filed: Nov. 25, 2005

(30) Foreign Application Priority Data
Nov. 25, 2005 (DE) 10 2004 057 84.1

(51) Int. Cl. G06F 17/30

(52) U.S. Cl. 707/3

(57) ABSTRACT

The invention pertains to a device and methods for requesting, querying, provisioning, supplying, managing and assignment of additional data for a video that consists of a plurality of video frames, via which by means of additional data or terms assigned link data, users of videos receive contents and term-related link data to further web information.

### BACKGROUND OF THE INVENTION

The present invention pertains to an apparatus and method for the assignment, query, request, providing, management and assignment of additional data to a video that consist of a plurality of video frames as set forth in the classifying portion of claim 1.

### Description to the Related Art

The assignment of a large number of additional data or supplementary data to a video or a plurality of videos is very expensive or costly and can be reached in the state of the art technology only insufficient efficiently. In particular, the assignment of a larger set of additional data is not solved in real time in state of the art technology. In addition, the administration, maintenance or management of detailed video-related data is solved insufficiently.

Furthermore the subsequent adding of metadata or additional data in existing or available content files is very expensive and sometimes almost impossible to execute or to carry out, in particular if the file is not in the direct access by the editor or creator anymore. Because for content that is sent and stored locally by the user or viewer, related additional data can't be updated subsequently, and because content may be used after months or years, this restriction can be contrary to the use of these methods for an offline use of this content.

A general disadvantage of existing technologies exists therein, that the content owner or publisher of distributed material or videos doesn't have any direct contact or access and no connection to the content after publication. Furthermore, the user or viewer of the content cannot create a connection from the user or viewer side to the content owner, even if the user or viewer wishes to do this. The close contact between content and the real content owner indicated by possession is lost after the publication and therefore also with the possession related opportunity to make a direct contact with the users or viewer. The creation of a connection, which can contain, within an embodiment for example the opportunity of communication, within the known state of the art technology only be recreated with difficulties, in an insufficient and unreliable manner.

Special terms such as brand names have legal protection in their use. In the Internet, this protection can only be enforced with difficulty. Brand names are used in an unauthorized manner in order to improve status of a product or service and/or getting attention, which would not have been there without the use of this brand name. The damage for the customer or for the brand names is unavoidable, if the customer has by means of the name received something which qualitatively does not show the same as of by means of this name in its original form.

The sale of pirated products under brand names is already a serious problem in the Internet and it would, due to reduced access costs to direct response marketing methods, which are connected to video and/or to TV programs or shows, would be significantly increased. A control of the use of names, in order to make the attention directly commercially utilizable, would be advantageously and is until now not solved in connection or relationship with video in the state of the art technology.

Additional data, in particular content-related additional data related to videos, are description data or metadata which are either contained within the video data or stored in parallel to a video in a file or within a database as a data record. An example is the time index-related description of a video which is contained by files in a common file or a collection which also is called a story book. Data for a video or film (Movie or video) can also be stored in a database, such as in the Internet Movie database (IMDB.com) and can be provided for the use. These data are providing a direct connection to the video in which the user has viewed, and do not provide any content-related data to the scenes that the user is currently viewing.

Another known method from the state of the art technology consists of the storage of additional data as metadata, which are stored in different positions or locations within the binary video data. In addition, the time index can be used to store scene specific metadata for content within a file or a database as a data set. A program is then capable to use these data as trigger in the file or in the database in order to display additional data or to provide them to users for request.

The direct assignment of link data within scenes, such as in hypervideos, leads to the problem of administration or management of the link data and the validation or verification, whether files refer to the link data are available, in particular, if the video is not in the direct access of an information provider. Additionally, the update of data within larger changes, such as change of the domain address, is expensive or costly.

With products such as i-Photo (iLive) and iView for the Apple OS, hierarchical organized data are managed by means of additional data in a parallel file and/or database. There is within this hierarchical structure no link in particular to any paths to outside resources. In addition, pictures and/or video files are only recognized via file names. This administration or management has therefore the disadvantage, that the renaming or distribution of the data within the Internet the additional data no longer correctly be assigned to the documents from the original publication and/or administration context, in particular also for the data that are contained in the database.

A video can be stored in different formats, and/or run or executed by means of different codecs, and/or distributed. The additional data for this video are independent of the codec or the video format. A problem from the state of the art technology exists, that the same additional data are assigned to these different formats and/or codecs, without that these additional data within the files or within this assigned database have to be stored or that no additional registration process will be necessary.

Furthermore the problem exists, that by means of relatively small changes within videos, such as shortening of the video or the rearranging or newly arranging of video scenes within the video or by means of comparable processes or methods and/or results, as for example it appears after video-editing, the additional data have to be newly defined or manually adapted. In the state of the art technology the reuse of external managed additional data, as in a database, is only via manual effort and not automatically possible.

Definition

In the following text, the term “content” is interpreted or understood as: data, file(s) or data-stream(s), and in particular the actual representation of what the data represents or stands for in a suitable, adapted and/or appropriate display or output medium. The content can be the same, whether or not it is represented in different data records or data formats, where its binary output is represented differently.

In the following text, the term “video” is interpreted or understood as: temporal change of pictures or images. The individual pictures (single images or frames) consist of pixel or by means of which pictures or images are generated from data sets. Digital videos consist of data sets which are transformed into motion pictures or images by means of a video visualization unit. The single images or frames within the video are encoded and/or compressed. The decoding method for the representation of the pictures or images is carried out by means of software instructions within software components, which are called codecs.

A scene is a section of a film or video, which consists of one or several sections that refer to a part of a common action typically within a single location. The extent or scope of a scene of a film is typically determined by the change of location or by the arrangement or composition of shown objects, materials or actions.

Complete or entire pictures or images within videos are called frames. Pictures or images, which are represented or displayed within a video, are calculated and/or interpolated by means of differences or interpolations or mathematical methods. In the following text, the term “video frame” is used to represent a “snapshot” or freeze frame or a frame or a calculated and displayable picture or image from a video/audio stream (or its corresponding data stream) or audio/video file.

In the following text, the term “video data” is used to represent audio/video data or data which are transmitted or sent by means of TV or which are played by a video recorder or from a video file.

In an extreme case the video can consist of only a single picture or a picture format such as animated GIF with an inherent transitory change of the output.

Additional data are content-related or content specific if they refer to the content of the corresponding video or video content. In particular the additional data relate within the content-relatedness to the relationship of the video frame to the content in the video frame handled or displayed as object(s), animal(s) or species of animal(s), plant(s) or species of plant(s), product(s), trademark(s), technology, technologies, transportation mean(s), machine(s), person(s), action(s), connection(s), relationship(s), context(s), situation(s), work(s) of art or piece(s) of artwork, effect(s), cause(s), feature(s), information, formula(s), recipe(s), experience(s), building(s), location(s), region(s), street(s), environment(s), history, histories, results, story, stories, idea(s), opinion(s), value(s), explanation(s), and/or rationale(s), reasoning(s) or the like with corresponding information, which can be comprehended in these categories or included in these categories or themes.

Term data or category names are names and/or key concepts or key terms and/or a composition of features which are understood as the identical features in objects and facts. Term data can be words or a composite collection of words in the form of a phrase or an expression. Terms can be synonymous, in which different words are representing identical concept/terms or they could be homonyms, in which one word can stand for different concepts/terms. In addition, terms can represent general concepts or terms, in which different, individual objects can be combined with regard to their common features or they can represent individual terms if they describe individual objects or persons which arise by variations of single features and/or over certain time periods.

Furthermore, terms can be decomposed into their features or terms can be regarded or understood as a collection of features. A feature is a component of a term. Features are divided or segmented into essential and/or non-essential or insignificant features, whereby an essential feature is also called a necessary feature. An insignificant feature is an accidental or coincidental feature that also can be omitted out of the description. A feature is a distinctive or characteristic feature if it is necessary for the corresponding term definition. A distinctive feature is delimiting a term from others. Objects come under a concept by having their characteristics as features.

In the following, the term feature is regarded as a realized feature, a function, an attribute or a quality defined, which is common for classes of objects, processes, relations, events, an action, a person or group of persons exists and/or is used to distinguishes each from the other.

An attribute is regarded as the assignment of a feature to a concrete object. An attribute defines and describes a concrete object. An attribute has a corresponding value, which is called an attribute value.

Description of the Solution

The purpose of the present invention is to create an apparatus and a method for the assignment, query, request, providing, management and assignment of additional data to a video that consists of a plurality of video frames as set forth in the classifying portion of claim 1, in which by means of additional data or terms the corresponding link data, users of videos can receive content- or term related link data to further information, in particular to web information.

The objective is achieved by the apparatus with the features of Claim 1; in particular, all features that are revealed in the present documents shall be regarded in arbitrary combination as relevant and disclosed for the invention; advantageous development of the invention is described in the related, dependent claims.

Videos or films can be divided up into scenes in which there is a scene from a connected set of video frames and the scenes can be provided with a plurality of additional data or terms. The relation between the additional data or terms and the scenes is established, created or used by the scene term relationship unit and used for the data request.

In a manner according to the invention, the client-sided assigning, providing, managing, requesting, querying and/or transferring of data takes place on an electronic data processing unit, which is usually a PC or server with a database. In particular the data processing unit is connected with the Internet and data are transferred or received over the Internet. The data processing unit processes can process data as a server, in particular the server is prepared to be a database server or a web server or a web service.

The transferred or received picture element data include data, by means of the pictures or a single picture can be identified or by means of that it can be selected. Video data or video films consist of or are composed of at least one scene, which consists of one or a plurality of video frames. The scenes subdivide or segment or partition the video data. Scenes are or describe or define sets of video frames.

The device, according to the invention, provides a first assignment, classification or correlation unit, which in the following is also called a picture scene relationship unit and which is suitable for assigning a plurality of video frames to a scene and which is realized for producing corresponding first assignment, classification or correlation data, and which is, in the following, also called picture scene assignment, classification or correlation data.

The device also shows a second assignment, classification or correlation unit, which in the following is also called a scene term relationship unit, and which is designed to assign at least one identification data element, which in the following is also called term or term data, and which is designed to be assigned to the scene and for the production of corresponding second assignment, classification or correlation data, which in the following is called scene term assignment, classification or correlation data.

The device comprises also a third assignment, classification or correlation unit, which in the following is also called scene link data relationship unit and which is suitable to assign one, external data, identifying, connection data element to the identification or category data element or term data, which in the following is also called link data, and which is designed for producing, creating or generating corresponding third assignment, classification or correlation data, which in the following is also called term link data assignment, classification or correlation data.

The device also comprises a request unit that is usable by a user, which is designed in a manner that the user by means of a selection device can select and/or receive data, so that a video frame or a plurality of video frames can be selected and so that by evaluating the first, second and third assignment, classification or correlation data the user is offered or is gaining access to the link data, which are assigned to the select video frames.

Picture element data are data which are used to define images, for instance pixels or the like, and/or they are data that can be used to identify images, for instance thumbnails of images or digital signature data or digital fingerprint data or the like, and/or they are data that can be used to determine video frames within a context, in particular within video data, as for instance with unique names or identifiers of video data and the serialization of video frames within these video data or to the moment of the appearance of the image as the video data plays and the value of a mathematical hash code of the video image or of the video frame correlated or assigned GUID (Globally Unique Identifier or Global Universal Identifier) or the like.

A hyperlink is a data element that refers to another data element by means of which a user can access data or can get data transferred if he activates or follows the hyperlink. Hyperlinks are realized by URLs, in which an (IP) address of an (in particular external) server and a path or a parameter list is contained, which is applied or executed on the (external) server in order to extract and/or to assign data.

Content-relatedness relates to the relationship of the video frame to the content in the video frame handled or displayed as object(s), animal(s) or species of animal(s), plant(s) or species of plant(s), product(s), trademark(s), technology, technologies, transportation mean(s), machine(s), person(s), action(s), connection(s), relationship(s), context(s), situation(s), work(s) of art or piece(s) of artwork, effect(s), cause(s), feature(s), information, formula(s), recipe(s), experience(s), building(s), location(s), region(s), street(s), environment(s), history, histories, results, story, stories, idea(s), opinion(s), value(s), explanation(s), and/or rationale(s), reasoning(s) or the like with corresponding information, which can be comprehended in these categories or included in these categories or themes.

The signature data are determined by means of a signature data unit. Video frame-dependent or scene-dependent signature data can be extracted from data which are described as signature data in the following. The signature data can be assigned to single video frames and/or to a set, group or quantity of video frames, such as scenes, or the complete content or video. These signature data or fingerprint data are calculated by means of mathematical methods, in particular a hash method or a digital signature or a proprietary picture or image transformation method, by means of a single video frame or by means of a predetermined set of video frames. The data, from which the signature data as metadata can be extracted, are binary or ASCII-based. They can be extracted by means of a compression method or data transfer or transformation method. Furthermore these signature data can be stored within the encoded metadata. The signature data can be calculated in a manner, so that they are invariant with respect to transformations, as they appear while storing in different picture or image sizes (such as JPEG, GIF, and PNG etc.).

A hash value is a scalar value which is calculated from a more complex data structure like a character string, objects, or like that by means of a hash function.

The hash function is a function in which input from a (normally) large source or original set produces an output of a (generally) smaller target set (which is the hash value that is a subset of the natural numbers or ASCII-based characters).

Electronic or digital signature or digital fingerprints are electronic data, which are calculated from digital content. With known fingerprint algorithms such as MD5 or SHA-1 the change of a single bit can lead to the change of the digital fingerprint. With more insensitive fingerprint methods the change of several pixels can lead to the same signature or to the same fingerprint. Preferably within the context of this invention is the usage of an insensitive signature or fingerprint algorithm.

In an embodiment of the invention, the assignment, classification or correlation units are elements or components of a database. In the context of this invention, the term database is synonymous with or equivalent to relational database systems or to file systems or to files or to the object-oriented data assignment by means of object-oriented technology. Storing and/or managing of data can be done by means of relational or object-oriented tables and databases. Features of elements can be described within data records or data sets of a table by means of attributes and their values or they can be assigned to the actual table by means of additional feature tables.

Additionally, in a database, video frames are managed by means of structured storage, queries, management and administration of description data of a plurality of video frames or in a table for video frames or in a suitable object. A video frame is then a single element of the plurality of video frames, which is also an element for the output, displaying or representation of a single image or picture from a video.

In the context of the invention the term table also includes the representation of data by means of object technologies.

Additionally, within a database, scenes are managed via a means for structured storage, query, management and administration of description data of a plurality of scenes or in a table of scenes or in a suitable object. A scene of the video is then a single element out of the plurality of scenes, which is formed or created from the ongoing set or plurality of video frames.

Furthermore, within the database, terms are managed via a means for structured storage, query, management and administration of description data of a plurality of content-related terms or in a table of terms or in a suitable object. A term is then a single element of the plurality of content-related terms or text, which have a meaning in a predetermined language and are expressed by the corresponding word within the text.

Furthermore, within the database, link data are managed via a means for structured storage, query, management and administration of description data of a plurality of link-data, or in a table of link-data or in a suitable object. The link data consist of single data elements of the plurality of link data which consist of a plurality of, preferably textual, data, which include hyperlinks, text, and link data within pictures and/or videos.

A picture scene relationship unit manages the assignment, classification or correlation data or the relation data between single elements of the video frame table or object and the elements of the scene table. The picture scene relationship unit is an intermediate table or M:N relation between video frames and scenes. A video frame can therefore be contained in one or several scenes or a scene can be contained in one or more video frames. The relationship unit can be developed, constructed, created or established in a manner that a sequence of video images or pictures that are consecutively and/or sequentially numbered, is stored by means of an initial value and/or final value within the picture scene relationship unit. Also the cases in which a video frame is not assigned to a scene or a scene is not assigned to a video frame shall hereby be regarded as revealed or disclosed. Preferably, a video frame shall be assigned to at least one scene.

A scene term relationship unit manages the assignment, classification or correlation data or the relation data between single elements of the scene table and the elements of the term table. The scene term relationship unit is an intermediate table or M:N relation between the scenes and terms. Therefore a scene can be assigned to one or several terms or a term can be assigned to one or several scenes. Also the cases in which a term is not assigned to any scene or a scene is not assigned to any term shall hereby be regarded as revealed or disclosed. Preferably at least one term shall be assigned to one scene.

A term link data relationship unit manages the assignment, classification or correlation data or the relation data between single elements of the term table and the elements of the link data table. The term link data relationship unit is an intermediate table or M:N relation between the term and link data. Therefore a term can be assign to one or several link data, or one link data element can be assigned to one or several terms. Also the cases in which a term is not assigned to link data or link data are not assigned to a term shall hereby be regarded as revealed or disclosed. Preferably at least one link data element shall be assigned to one term.

A video frame is identified by means of a video frame identification means within the video frame table via assigned video frame identification data and which is extracted from the table. Video frame identification data can be called, named, designated or realized as picture element data such as pixels or hash codes or signatures or fingerprint data or video context dependent data, which are in a preferred manner contained in the video frame table or in a table assigned to the video frame table.

With the identified video frame a plurality of scenes, which in the following is called set, amount or volume of scenes, or short scene set, can be extracted or assigned by means of the picture scene relationship unit, and each or every element of the set, amount or volume of scenes can by means of the scene term relationship unit be extracted or assigned with a plurality of content-related terms, which creates or forms the term set. Every or each element within the volume, amount or set of terms then can be extracted or be assigned by means of a term link data relationship unit from the plurality of link data, which then form or create a link data set.

According to the preferred embodiment of the invention by means of a provisioning or supply unit, the volume or set of scenes and/or the volume or set of terms and/or the link data set can be provided. The provisioning or supply unit can provide the mentioned set, amount or volume in a form and/or structure suitable for the further processing of data.

In another embodiment of the invention the data processing unit comprises an input devise or request unit, which is either local or by means of Internet externally available and is realized in the data processing unit as a data interface.

In another embodiment of the invention video data are managed in a database via a means of structured storage, query, request and administration of description data of a plurality of videos or in a table of video data. A video or video data set is described by a single element of the plurality of video data.

In another embodiment of the invention, the data processing unit is comprised of a video data image relationship unit by means of which assignment, classification or correlation data or the relationship data are managed between single elements of the video data table and the elements of the video frame table. The video data picture relationship unit is an intermediate table or M:N relation between the video data and video frame data. Therefore a video can assign on one or several video frame data or an element of the video frame data can be assigned to one or several videos. Also the cases in which a video frame is not assigned to any video data set or a video is not assigned to any video frame data shall hereby be regarded as revealed or disclosed.

In another embodiment of the invention, the videos can by means of the video data scene relationship unit, which are managed by means of the assignment, classification or correlation data or via the relation data between a single element of the video data table and the elements of the scene table, directly be assigned to a set of corresponding scenes. The video data scene relationship unit is an intermediate table or M:N relation between the video data and scene data. Therefore a video can be assigned to one or several scenes or a scene can be assigned to one or several videos. Also the cases in which a scene is not assigned to any video or a video is not assigned to any scene shall hereby be regarded as revealed or disclosed.

In another embodiment of the invention, the videos can by means of the video data term relationship unit, which are managed by means of the assignment, classification or correlation data or via the relation data between a single element of the video data table and the elements of the term table, directly be assigned to a set of corresponding terms. The video data term relationship unit is an intermediate table or M:N relation between the video data and term data. Therefore a video can assign on one or several terms or a term can be assigned to one or several videos. Also the cases in which a term is not assigned to any video or a video is not assigned to any term shall hereby be regarded as revealed or disclosed.

The terms within the term unit can be organized or ordered in a hierarchy and/or network-like and/or object oriented manner.

In the hierarchical order of the terms a sub term is assigned to a more generic term. Because terms consist of features, a sub term can contain or provide an additional feature compared with a more generic term. In the network-like order of terms, terms can be connected with each other by means of link data. Within hierarchies different branches or terms can be connected within a hierarchical term order by means of link data. In the object-oriented order the terms contain additional attributes whose number can potentially be unlimited. These attributes can show or comprise common attribute values. Profiles can be defined efficiently and can be introduced by means of attribute values.

A profile consists of an agreed or arranged subset of predefined data. Comprehensive terms have many optional features. A profile contains configurations and/or other data which are related to the presetting of the data. Profiles can be associated with frequent activities or frequent assignments.

So, besides terms term profiles can also be created, in which several terms or a defined (sub-) set of terms comprising a common feature or value, can be applied or assigned on a scene with an assignment of several terms at the same time or in one (manual) processing step. The profile feature can in a preferred manner be realized by means of common attribute, which are assigned to terms. The application of a profile then consists in a predetermined or regular change to attribute values by means of profile data.

In addition, besides the terms within term profiles, the assigned link data can also be assigned to a subset of these link data as attribute modification data that can be assigned to the term profile.

In the following these term profiles are called specialized term profiles since instead of the entire set of corresponding link data only at least one term is assigned to a subset of these link data by the specialized term profile.

This subset of link data comprises a common feature, which is assigned to these data. By means of specialized term profiles a scene can be assigned within one operational step to a large number of these (term) data, which are assigned to different areas distributed within a hierarchical structure. The profile feature can technically most efficiently and in a preferred manner be realized by means of common attributes, which are assigned to terms and the link data.

Furthermore, besides link data, link data profiles can also be created for a predetermined term, in which several selected link data elements or a defined (sub-) set of link data elements comprising a common feature or value, can be applied or assigned to another predetermined term with an assignment of several link data at the same time or in one (manual) processing step. The profile feature can technically most efficiently and in a preferred manner be realized by means of attributes, which are assigned to the link data.

Furthermore, besides scenes, scene profiles can also be created for a predetermined video, in which several selected scenes or a defined (sub-) set of scenes comprise a common feature or value, can be applied or assigned via one (manual) processing step. The profile feature can technically most efficiently and in a preferred manner be realized by means of attributes, which are assigned to the scenes.

In the device, according to the invention, and its related methods, scene profiles, term profiles, specialized term profiles and data link profiles are used by revisers, in the following also called editors, in order to assign fast and efficiently a large number or amount or volume of content or additional data and in particular link data. In particular, the following method is applied in connection with the device according to the invention.

In another embodiment of the invention video data and video frames can be stored on the corresponding tables or objects within the device, according to the invention, on which this process is called registration.

In accordance with the invention, scenes can furthermore be defined by means of the contained video frames and/or the numeric beginning and final value by means of a serialization or numeration scheme, in which the video frames of a scene belong or can be assigned to a common video data set or data record and is stored in the table or object of the device according to the invention.

In accordance to the invention, further terms can be stored in the corresponding tables or objects in the device according to the invention.

In another embodiment of the invention a separate process, in the following also called validation of terms, can be used in the data processing apparatus and/or by means of term verification, inspection and examination server that is connected via the electronic network for the validation of the usability or correctness of the term.

The verification, inspection and examination server can be a catalogue of terms or it can be a server on which the use of brand names is checked and/or connected with additional data. The additional data, delivered by the server, can constitute or initiate the business preparation or development between the user of the brand name and its owner or agents or the data could contain conditions, which the user of the brand name has to satisfy, such as a payment for the use of the brand name, or the mandatory use of the link data, which must be included in the corresponding link data table and/or the restriction or condition that no further link data to the brand name should be included in the link data table. In addition, these data restrictions, which are delivered or informed by the verification, inspection and examination server, can contain and prohibit assignment to protected terms on scenes or videos or video genres.

In accordance with the invention assignments of terms on scenes to scenes to terms can be contained or inserted in the corresponding intermediate tables or in the scene term relationship unit of the appliance according to the invention.

In accordance with the invention assignments of terms to video data or video data to terms can be contained or inserted in the corresponding intermediate tables or in the video data term relationship unit of the appliance according to the invention.

In accordance with the invention assignments of scenes to video data or video data to scenes can be contained or inserted in the corresponding intermediate tables or in the scene term relationship unit of the appliance according to the invention.

In accordance with the invention, further link data can be inserted or written down in the corresponding table of the appliance according to the invention. Additionally, the corresponding assignment of link-data to terms can be inserted in the corresponding intermediate table or in the term-link-data relationship unit of the appliance according to the invention.

In accordance with the invention, scene profiles can be defined, changed and updated whereby these profiles can be created, generated and/or assigned by means of additional tables and/or additional attributes, which are assigned to elements of the scene table.

In accordance with the invention, specialized term profiles can be defined, changed and updated whereby these profiles can be created, generated and/or assigned by means of additional tables and/or additional attributes, which are assigned to elements of the term table and elements of the link data table.

In accordance with the invention, link data profiles can be defined, changed and updated whereby these profiles can be created, generated and/or assigned by means of additional tables and/or additional attributes, which are assigned to elements of the link data table.

In accordance with the invention, scene profiles can be defined, changed and updated whereby these profiles can be created, generated and/or assigned by means of additional tables and/or additional attributes, which are assigned to elements of the scene table.

In accordance with the invention, term profile data profiles can be applied on video data, or on a scene or on a scene profile so that within the table of the appliance according to the invention corresponding or appropriate combinations of terms within the corresponding profile and videos or video data or on the scenes or on the plurality of scenes, which are contained in the scene profiles could be inserted or defined by means of additional tables or by means of single data sets in the corresponding relationship unit of the database or to the appliance according to the invention.

In accordance with the invention specialized term profile data profiles can be applied on video data, or on a scene or on a scene profile so that within the table of the appliance according to the invention corresponding or appropriate combinations of terms within the corresponding profile and videos or video data or on the scenes or on the plurality of scenes, which are contained in the scene profiles could be inserted or defined by means of additional tables or by means of single data sets in the corresponding relationship unit of the database or to the appliance according to the invention and used or applied to the link data, which belongs to the terms, and which are included or defined by means of attributes or tables.

In accordance with the invention scene profiles can be applied on video data so that within the table of the appliance according to the invention corresponding or appropriate combinations of scenes within the corresponding profile and video data could be inserted by means of additional tables or by means of single data sets in the corresponding relationship unit of the database or to the appliance according to the invention.

In accordance with the invention link data profiles can be applied on terms so that within the table of the appliance according to the invention corresponding or appropriate combinations of link data within the corresponding profile and terms could be inserted by means of additional tables or by means of single data sets in the corresponding relationship unit of the database or to the appliance according to the invention.

Server-sided additional data can comprise or provide user activatable choices, menu bars or activatable options, which are equipped with hyperlink(s) and/or with text, metadata, picture(s), image(s), video(s) or the like. In the simplest version, the user activatable options or choices can consist of a plurality of text data and/or image data and/or hyperlinks.

In this client-sided activation or selection by a user a data set or a plurality of data sets is transferred to a server unit. The data, which are transmitted by a client-sided functional unit or transmission unit to the server, contained in a preferred embodiment of the content signature data, are assigned which on the server, according to the invention are assigned to the signature data, to a scene or to a plurality of scenes The scenes are then assigned to additional data or terms, such as the category or topic name or the theme name, by means of the scene term relationship unit on the server unit.

The terms or additional data in the scene term relationship unit can be person's or people's name(s), personal description(s), characterization(s) of person(s), or the like, or product name(s), product description(s), product tag(s), product parameter(s), commercial symbol(s), trademark(s) or the like, or toponym(s), place name(s), landscape(s) or territory name(s), street name(s) or the like, or building or structure name(s), description(s) of a building or structure, sign(s), symbol(s) or attribute(s) of a building or structure or the like, or means for transportation or conveyance, description(s) of transportation or conveyance, or name(s) of (a) work(s) of art, description(s) of (a) work(s) of art the like, or animal name(s), animal species, class or classes of animals, animal description(s), characterization(s) of animals or the like, or plant name(s), name(s) of plant species, plant description(s), characterization(s) of plant(s) or the like, or event name(s), event description(s), food name(s), recipe(s), recipe name(s) or recipe description(s) or the like, or description(s) of situation(s), object description(s) for technical object(s), production or manufacturing facilities, machine(s), engine(s), robot(s), or technical description(s) or the like, or chemical, mathematical or physical formulas, astronomical picture(s) or image(s), images from scientific activities or the like, or content name(s), content type data, content description(s), content metadata or the like.

Additionally, additional data can be name(s) or description(s) of light ratio(s), amount of light, special effect(s), surface(s) or physical description data, size, extent, description or descriptive parameter(s) or name(s) and description(s) for movement(s) of person(s) or object(s) or group(s) or the like, role(s) or function(s) of person(s) or group(s) of person(s), characteristic(s) or attribute(s) of (an) object(s) or characteristic(s) or attribute(s) of person(s), or description(s) of simulation(s), description(s) of method(s) or procedure(s), description(s) of utilization(s) or use(s), hint(s) or advice on danger(s) or hazard(s) or the like, or data referring to the color spectrum, or data on the correlation or context of scene(s), such as scene sequence(s), scene hierarchy or hierarchies, or scene description(s) or the like, or visual, sound or multimedia contextual descriptions or the like, chronological or causal sequential or succession or description(s) of the background(s) or of geographic or relative positioning or of author name(s), manufacturer name(s), editor name(s), supporter name(s) or sponsor name(s) or legal partnership(s) or proprietorship(s) or digital rights management description(s) or symbol name(s) or symbol description(s) or trademark-sign(s) or symbol(s).

The terms or additional data, such as category names and/or corresponding or related attributes and/or metadata, which are stored in the server-side units such as the scene term relationship unit or term link data relationship unit as scenes and/or hyperlink related data, can be indexed and searched together with the corresponding content or scene names as text data and/or text data related link data can be indexed and be made searchable in a text oriented search engine so that multi-media content data can be searched by means of text-related search words and/or attributes and the videos and/or video data can be found and/or the videos and/or video data can be categorized automatically.

### BRIEF DESCRIPTION OF THE DRAWINGS

Further advantages, features and details of the invention will be apparent from the following descriptions of preferred embodiments and with references to the following drawings:

FIG. 1: a schematic image for the client-sided request, query, assignment, output and display of server-side additional data.

FIG. 2: a flow chart for the client-sided request, query, assignment, output and display of server-side additional data.

### DETAILED DESCRIPTION OF THE INVENTION

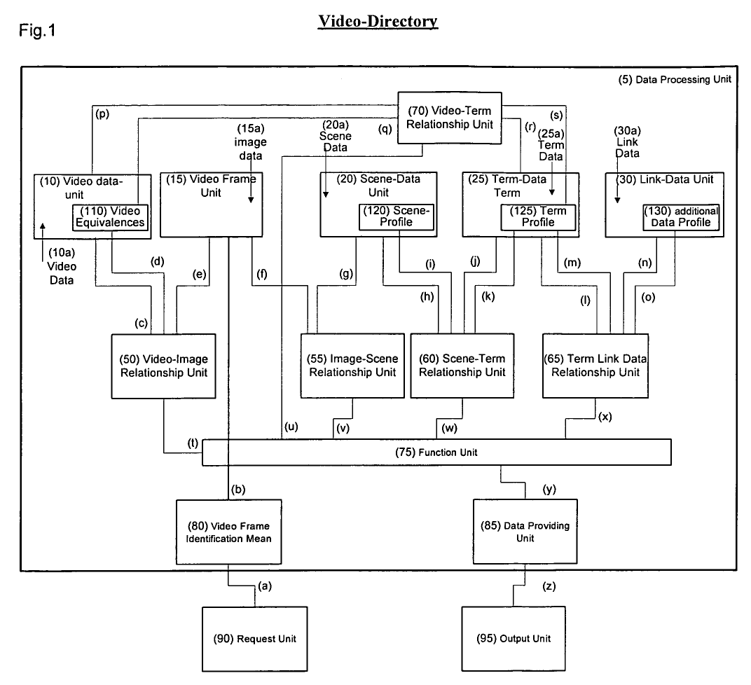

FIG. 1 describes a schematic image for the client-sided request, query, assignment, output and display of server-sided additional data or content-related terms, which by means of a data processing unit (5) can be assigned to video data (10a).

The data processing unit (5) is connected via the electronic network (a), (z) with an external request unit (90) and with the client-sided output unit (95). The data transmission takes place in the electronic network, typically via TCP-IP. A database is installed as a functional unit (75) on the data processing unit (5). The database manages a table for the administration for the storage of video data (10), of video frames (15), a table to the administration of scenes (15), a table to the administration of terms (15) and a table to the administration of link data (15). The tables contain primary keys, which as corresponding reference values, are used or inserted in the intermediate tables (50), (55) (60), (65) and (70). The intermediate table enables the M:N relationship between the directly connected tables.

Methods for Use (Operation)

As method for the calculation of video frame identification means (80), the insensitive fingerprint method is used or applied. By means of the query, requesting or input unit (90), which is activated by a user, an extracted picture is transmitted or transferred to the video frame identification means (80). By means of the video frame identification means (80), on which the fingerprint algorithm is running, a color normalization or standardization of the picture is done. Within the color normalization or standardization by means of a color histogram technique, color distortions are reduced in a predetermined manner. A subsequent gray scale calculation or computation for all pixels leads to a gray scale image. Subsequently, the thumbnail can be calculated via averaging (mathematical average value creation) over all pixels that are assigned to a pixel within the thumbnail, due to the reduction in size. The thumbnail has a size of 16*16, whereby this has been reduced from the original picture to the thumbnail in a linear manner. The limits of the area, over which the pixel values have been averaged, arise from equidistant widths and heights. Considering the size of the thumbnail is 16×16, the pixel width of the picture and the pixel height of the picture must therefore be divided by 16. The fraction of a pixel between adjacent areas is considered within the averaging as a related fraction.

The fingerprint is transferred by means of the database or functional unit (75) to the video frame table (15) in order to extract from the video frame unit (15) the corresponding picture or image reference key value related to the fingerprint. The image reference key values, which is a primary key of the video frame table (15), is used to extract all scene data (20a) or scene data reference key value(s) from the relationship unit (55), which are assigned to the reference key value. The set of the scene data reference key values is then used to extract all corresponding term reference data from the scene term relationship unit (60). Additionally, all extracted term reference data are used to extract all reference key value data to the corresponding link data elements (30a) from the term link data relationship unit (65).

The picture reference key is the primary key for the video frame table (15). The scene data reference key is the primary key for the scene table (20). The term reference key is the primary key for the term table (25). The link data reference key is the primary key for the link data table (30). The reference key values which belong to reference keys are used to extract the data sets that are assigned as data to the reference key values from the corresponding tables. The reference key values are also contained in the relationship units by means of corresponding tables as references or foreign keys in an unchanged manner.

In particular the primary key from the term table (25) is used in order to generate or create the menu data for the output or display and the corresponding related link data (30a), which are defined via the relationships and references within the term link data relationship unit (65), in order to assign single terms on the menu via link data lists—and can be output on the client—sided corresponding to the related installed output or display logic. Within the framework of this embodiment the menu can be realized with a title and description, while the link data (30a) contains title, description and a reference on a related, corresponding icon.

The data, which are extracted out of the tables, are transformed into a data format for the provisioning or supply unit (85), which is read out by the client-sided output device (95) and which is directly suitable for the client-sided representation or output and/or can be distributed or output by means of interpretation by the client unit in a meaningful manner.

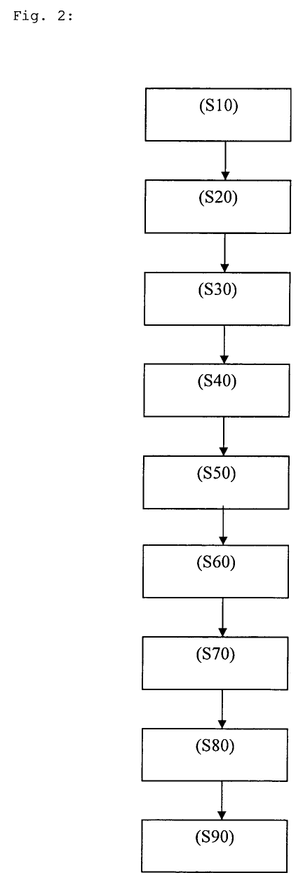

FIG. 2 describes a concrete method for the operation of the device according to the invention.

In the process step (S10), the request or query unit (90), which is contained on a PC unit or the like, is used for the extraction or assignment of data from a video. This process can be triggered by clicking on a video so that by means of program logic that is installed on the client, data will be transferred, transmitted or assigned to the identification unit (80). In the process step (S20), the identification means (80) is used to extract data by means of which a video frame can be identified and/or found in a table. These extracted data can provide fingerprint data by means of the fingerprint algorithm, which are stored in the video frame table to all video frames. The reference data, which are assigned to the fingerprint, are extracted in the process step (S30) from the video frame table. These reference data are preferably unique; however, it does not have to be necessarily this way, since the database logic if necessary may ignore parts of the video frame when it is searched in the video frame table. These areas could be the corners of the image, in which the broadcaster preferably inserts their broadcaster logos. In the process step (S40) the scene-dependent reference values, which are related to the video frame reference data, are selected or extracted from the image scene relationship unit (55). Process step (S50) selects or extracts the term-dependent reference value that is related to the scene reference data from the scene term relationship unit (60). Process step (S60) selects or extracts the link data dependent reference values related to the term reference data from the link data image relationship unit (65). Process step (S60) selects or extracts link data dependent reference values from the term link data relationship unit (70) by means of the term reference data. In the process step (S70) all or a selected, algorithmically determined subset of the extracted or selected reference data are used to provide corresponding scene data and/or term data and/or link data to the provisioning or supply unit (85). The reference data are used to extract the corresponding additional data from the scene unit (20), from the term unit (25) and from the link data unit (30). In the process step (S80) the provided additional data provided are transferred to the visualization/output/representation unit. In the process step (S90) the additional data are displayed or output on an output device (95) such as a PC or the like, so that the user is able to view or receive the additional data for a video.

Methods for Processing Data, Method for Operation

The editor registers videos on the device, according to the invention, by means of transmitting, assigning or transferring of video data (10a) and all corresponding video frames (15a) that related to the video data (10a), or a selected part or subset of these video frames, to the video data unit (10) and video frame unit (15). The video frames (15a) and/or video data (10a) are either processed or extracted on the device, according to the invention, so that the corresponding data can be transformed directly and be used in video data (10a) and/or video images that are insertable in a table or are already in a structure so that the accompanying data can be inserted in the video data (10) and video frame table (15a). In particular, the corresponding fingerprint data are calculated for the video frames if they are not included in the corresponding or related data sets or data records. In the following text, videos are described or marked as registered, if the corresponding video data (10a) and/or video frames (15a) were inserted in the tables (10), (15). Also in the case that only a part of the mentioned data were inserted or a part of the data are designated as already inserted by the database and/or the insertion of the mentioned data are refused completely or partly or a part of the data is updated, shall be regarded as disclosed hereby.

The editor can, manually or by means of a software-sided tool manually or partly automated or entirely automated segmenting the set of data that belongs to a video into sets of video frames. This process is called scene separation or segmentation. After a video has been registered and video frames are stored, this process of storing scene data can be initiated. If new video frames are added to a video within a scene, for example caused by the creation of new fingerprints which are based on another codec whereby the same video was used, then the new video frame element is stored and added as a new element to the video frame table and is stored in the context of the scenes as assignment, classification or correlation data in the relation data-unit (55).

The insertion of a new scene happens via the definition of new scenes in particular by corresponding accompanying data, such as title, description, or a picture which is typical of a scene. The scene can also be brought into a relationship with other scenes of the video in particular, in a connection according to data so that the scene is understood in its context by means of numbering or the like. In addition, the scene table can as a table self-referential table contain and/or provide a hierarchy of the scenes. Also in the case that only a part of the mentioned data were inserted or a part of the data are designated as already inserted by the database and/or the insertion of the mentioned data are refused completely or partly or a part of the data is updated, shall be regarded as disclosed hereby.

The editor can insert a new term as a data set in the term table (25) of the database by means of feature data and/or attribute data that belongs to the term. The new element with the term data can either be newly inserted without a relationship to the other terms or it can be inserted within the hierarchy of the already existing terms in a manner that a feature of the term is regarded as added and the term within a chain or at the end of a chain is either inserted or appended. For forming this chain of terms additional reference data can be inserted as a column of a table for the identification of the parent and/or child elements. The chain of terms can be changed or manipulated. Within the chain references or linking data can be inserted to other parts of the chain so that a strict hierarchy can be enlarged, enhanced or turned into a network. The application of rules can prevent the arising of meaningless, loop forming references.

Also the case, in which only a part of the mentioned data is inserted as a data set or data record, or a part of the data is described or marked by the database as already inserted and/or the insertion of the mentioned data is completely or partly refused, rejected or disapproved or a part of the data is updated, shall hereby be regarded as disclosed.

In a comparable manner new assignments are created or inserted such as data into the intermediate table with a combination of references on an element of the term table (25) and of an element of the scene table (20), or data into the intermediate table with a combination of references of an element of the term table (25) and of an element of the video data table (10), or data into the intermediate table with a combination of references on an element of the scene table (20) and on an element of the video data table (10), or data into the intermediate table with a combination of references of an element in the term table (20) and on an element in the link data table (30). Also the case, in which only a part of the mentioned data is described or marked as already inserted and/or the insertion of the mentioned data is completely or partly refused, rejected or disapproved or a part of the data is updated, shall hereby be regarded as disclosed.

The editor or reviser can extend or expand the definition or the content of the term profiles (125) via the insertion of new data elements into the unit or mean (25) or can extend or expand the definition or the content of the specialized term profiles (125a) via the insertion of new data elements in the units or means (25) and (30) or can extend or expand the definition or the content of the link data profiles (130) via the insertion of new data elements into the unit or mean (30) or can extend or expand the definition or the content of the scene profiles (120) via the insertion of new data elements into the unit or mean (20), whereby suitable and adapted attributes are set or assigned to a common value. The editor or reviser can change the profiles at anytime via modification or changing of the profiles and/or the belonging of elements (20a), (25a) and (30a) to profiles.

The editor or reviser can also, by using or applying the term profile (125) or the specialized term profile (125a), on video data (10a) or on scene data (20a) on a scene profile (120) that is created or formed by combinations of the mentioned data, be formed and/or created or produced in the corresponding relationship units. In addition, the editor can by applying scene profiles (120) to video data form, create or generate all (meaningful, in particular every not all that are available in the relationship unit) combinations of the mentioned data within the accompanying relationship unit.

Additionally, users can form and/or create or generate and/or modify new term link data relations (65a) in the term link data relationship unit (65) via assigning of the link data profiles (130) to a term.

In particular the user can by newly registering a video, which shows additional alternative video frames by means of the so-called cuts or by means of compressions, carry out subsequent processes manually, partly automated or entirely automated. A new scene is created which is assigned to the video or the class of equivalent videos, in particular when new video frames (in a coherent or connected manner) are created and inserted. Alternatively, a video can be inserted within the class of equivalent videos with a lower number of video frames in the database, in which even a scene can be missing completely. In this case the corresponding scene data (20a) can be inserted or registered without these removed scenes in the relationship unit. Correspondingly it is realized in the case if video frames are cut out, new ones are added and accompanying scenes are taken out and new scene data are added.

Description of the Database

The following output or display relations can directly be realized by the device and database, according to the invention. The corresponding data can be retrieved, selected, inserted and managed:

A video or an element of the video data table (10) can directly be assigned to N video frames or N scenes or N terms or N link data elements. Furthermore N scene profiles or N term profiles can be assigned to a video.

A video frame or an element of the video frame table (15) can be assigned to N video data or N scenes directly.

One scene or one element of the scene table (20) can be directly assigned to N video data or N video frames or N terms or N link data elements. Furthermore one scene can also be assigned to N scene profiles (120).

One term or an element of the term table (25) is directly assigned to N video data or N scenes or N terms or N link data elements. Furthermore N link data profiles (130) or N term profiles also can be assigned to one term.

A link data element or an element of the link data table (30) can be directly assigned to N terms, N scenes or N video data. Furthermore a scene can be assigned to N link data profiles or N term profiles.

A link data profile (130) can be assigned to N term profiles or can be contained in N specialized term profiles (125).

The database comprises the following tables: Video data table (10) (for the storage of video data, in particular data related to the video) with an assigned table by means of which equivalent videos as data sets are managed. The table of equivalent videos (110) can contain a title, description data, and metadata about the creation, history, marketing, actors, producers, bibliography data or the like. The video data table (10) is connected or linked to the video frame table (15). The video frame table (15) contains the administration, identification and/or identification data for all video data that are contained in the video. The video frame table (15) can contain format information, fingerprint data, metadata or the like.

A video is divided or segmented into scenes, in which the scene table (20) contains the set of all scenes, related to a predetermined or predefined video. Related to scenes, scene profiles (120) can be defined by means of attributes and corresponding values. In addition, the scenes of different videos can be combined or summarized in a set of equivalent scenes which comprise things in common in a content-related or more thematic or more formal manner. The scenes' categories can define topics or themes such as weather report(s), football match(es), newscast(s) or the like and therefore comprise a common content-related attribute. After these categories have been created and have been enhanced or enlarged by means of editors and newly registered video content, additional terms can be assigned and applied to these scenes at every later point in time of which then all scenes that are labeled in the same manner can benefit.

The scene table (20) consists of data for the definition of video frame sets of a video. The scene table (20) can also contain a scene title or scenes description or a reference to a picture or image or a plurality of pictures or images, which are typical for the scene or description data to the connection or linking between the scenes or the like. The scene table (20) comprises references by means of intermediate tables or M:N relations with the video data table (10), video frame table (15) and with scene profiles (120). The scene profiles (120) can also be contained in the scene data set and can be managed by means of attributes and attribute values.

The terms or word or key term table (25) can also contain title, description or references besides a reference to an image or picture or to a plurality of images or pictures. Term profiles (125) are defined and/or created or produced by means of intermediate tables or by means of attributes. The hierarchization of the terms which are preferably used for the structuring of the terms can realized by means of a self-referential table. Moreover, associations between terms can be defined by means of an intermediate table and/or by means of coupling values between the terms. Couplings from other databases, such as search engines or topic maps, or the like, can be used. The terms are linked via references (intermediate tables) with additional information such as link data (30a) (hyperlinks on web pages or on fixed links or connections with web pages or the like). The link data (30a) can comprise, besides the hyperlink, also a title, a data description and/or an image or icon and or a reference to an image and/or a video. Term profiles (125) consist of a set or volume of terms. The term profiles can additionally contain term profiles as elements.

In addition, the device, according to the invention, can comprise a relationship (intermediate table) between the video data (10) and term table (70) and/or term profiles and/or between scene tables and/or scene profile(s) and term tables and/or term profile(s) (60).

### FURTHER ADVANTAGES AND EMBODIMENTS

The hierarchization of the terms serves the organization of information. In addition, it serves the increase of the clarity from information both for the user and for the editor. Network-like links can create or establish additional connections and efficient relationships. The object-oriented organization of data is in particular suitable or adaptable for the profile generation by means of attributes.

The method, according to the invention, enables the assignment of additional information (terms, link data, web pages) and metadata to, as continuous stream(s) or video(s) published, video data, whereby the additional data and/or metadata in a content-related manner exerts on the successive content of the scene (which extends on several successive video frames) a context-describing effect or result. The scenes are then put or set into a direct relationship to a textual description of the contents by means of corresponding or related data.

The Internet provides users or viewers of a video by means of the invention the opportunity to extract, select and to display context related, in particular relevant, metadata in relationship to the video. In particular, by means of utilizing hyperlinks in the output the viewer or user has the opportunity to make use of a large number of relevant information.

Correspondingly, the link data can be shown by activation, wherein according to the invention the database can in particular efficiently realize the links to external data by means of the requests via the therein-contained ordering system and by means of the database that is managed by order levels. In particular, further or additional information can be produced in a fast manner and can be made accessible to the observer by means of stored relationships.

The use of the server-sided data by a client or a client-sided user or viewer can be reached efficiently by means of standardized interfaces, in particular by means of XML and XML over HTTP (SOAP—Simple Object Access Protocol).

The outputting or displaying of terms can be done by means of a menu, in which more detailed option can be created by means of pull-up, drop-down or explorer (list like or directory like) organization of information. A menu element can either be a link data element to further information or it can be a list or directory in which either further link data or additional menu options are offered. Alternatively also multimedia text (text with pictures, videos, animations or interactions) can be output, displayed or distributed after the activation of menu options. In this manner link data element can be output or displayed or the link data element can immediately be output or displayed in data, which can be called by means of link data.

In another extension or expansion of the invention the client-sided output or display of the menu can be created or generated by means of further configuration information related to the selected terms. Therefore, by means of the server appliance, according to the invention, a video frame can be extracted or assigned to a plurality of scene data, which can be assigned to a plural of extracted or assigned terms which can be extracted or indicated by means of a hierarchy from different steps and from incoherent or unconnected ranges of the term hierarchy. The terms which are assigned to the scenes can directly be realized within a one-level menu in which the terms are listed in linear manner and for an activation of a menu element, a list of hyperlinks appear at which the link data comprises a title, corresponding description and/or an icon. Since there is the opportunity that many data are displayed or output, the output can be limited in the menu list and in the hyperlink list to a restricted number and by means of a back/forward button for navigating between the output elements can be made possible.

In an extension or expansion of this concept, the menu elements can be grouped or separated into categories, e.g. as etiquettes (or tags) above the data window or that enable a representation in a two-step menu.

Another advantage of the invention is to give by means of using, including, inserting or embedding of a term verification, inspection and examination server or term verification, inspection and examination service as a means of enforcing rights related to brand names. The terms are used preferably as titles on the menu elements. With an external control of these terms or of the menu titles and with the validation of the terms with respect to possible brand name infringements, the operator of the device can, according to the invention, be informed automatically about these legal problems. Additionally, by means of this service, business preparation or developments can be made possible which would not arise without this service. The term examination, inspection or verification can be an additional web service, which can be offered to satisfy the interest of the trademark owner. By means of control over the menu title elements the brand name owner can enlarge or extend his influence on the use of his name in an advantageous manner and increase the value of the brand name significantly.

In a further embodiment of the invention the terms can be translated into the language of the user or viewer by means of a catalog unit or a translation unit before they are displayed on menu elements as a title.

Furthermore, within the output, instructions can be inserted in the data that are meant for the client by means of determining the sequence or order of the data. Alternatively the data can be changed in their order or sequence by means of instructions on the server, in particular within the processes for the supplying, provisioning or stocking of data. The sequence or order of the term or menu elements or the link data lists can be changed by instructions and determined or fixed before the output occurs. These methods can also be used, when term and link lists, based on the merging of scenes, must be merged and reordered. Alternatively another unit for the administration of menus can be provided or included in the device, according to the invention. The elements of this table are assigned to the video data or to the corresponding or related class of equivalent videos. Each element of menu data sets that belongs to a video distinguishes itself by the combination of terms related to a scene.

Since references to scene(s) and sub-scene(s) for a predefined or predetermined video frame an can be found, i.e., in both a scene and a sub-scene, and for another video frame the relationship to the scene can be determined, then together with the image-scene relationship, it can be determined which combination of scenes can be described with an equivalent menu data record.

This selected menu data set can then contain instructions about how the data that are extracted from the term and link data table are ordered in their sequence in its output or display. In another embodiment the data set can issue or output the menu and/or the corresponding or related link data in the form of an issuable or outputable data set. This embodiment has the advantage that the database does not have to search the intermediate tables every time in order to create the corresponding output data related to the video frames and collecting the data from the related tables. Furthermore the menu data can be assigned to specific, issuable menu data, which contains only the terms and instructions, which describe how the corresponding link data are ordered. Therefore the combination contain data that belong to the scene and to the terms that are contained or included in the issuable menu data, which are assigned by means of the term link data relationship unit to the link data elements. In another embodiment the link data can be included directly in the corresponding or related term data set as issuable link data.

Another realization of the invention can consist of a direct assignment of link data to scenes.

In another embodiment of the invention, the scenes can, by means of the scene link data relationship unit, which are managed by means of the assignment, classification or correlation data or via the relation data between a single element of the scene table and the elements of the link data table, directly be assigned to a set of corresponding link data. The scene link data relationship unit is an intermediate table or M:N relationship between the scene data and the link data. A scene therefore can be directly assigned to one or several link data or one element of the link data table can be assigned to one or several scenes. Also the cases, in which a scene is not assigned to any link data or an element of the link data is not assigned to any scene, shall hereby be regarded as revealed or disclosed.

Another advantage of the invention consists of the assignment of additional data or metadata to video material that is provided in different cuts or via different transmitters or broadcasters or via different transmission or distribution forms. The original material from a report is regularly longer or it is broadcast for the Internet or for a documentation channel in a prolonged version. In addition, there are movies, which are cut in the so-called directors cut or especially for the TV viewers or which are produced from different area-type segments. The corresponding or related additional data can be identical or can be adapted with insignificant changes to these different versions so that by means of the device and/or method, according to the invention, the additional data can be assigned efficiently to the different versions.

The invention offers the opportunity via the classification of scenes by means of category names and subcategories of the additional data to use the already above and/or below arranged (corresponding) terms from the term hierarchy.

The additional data which are delivered by the server, according to the Invention, can be used in the client-sided document visualization/output/representation unit, so that the corresponding content, for instance a scene or a temporal interval, which is in a predetermined timely distance to the requested element will not be output, so that for example within a parental control system, questionable content could be suppressed or skipped in the client-sided output by means of server-sided additional data. These methods comprise the advantage that parental control data does not have to provide this information to the display or player unit only at the beginning of the file or data stream. The display or player unit can start at any time within the video to play the content, and it can request corresponding data on the server side, in particular if the corresponding data doesn't exist in the video on the client-side any longer or was removed.

The server-sided additional data can, via the scene term relationship unit, also comprise coupling values, which can contain or define between the server-side available category or topic names or terms. The additional data within the relationship unit can contain parameter(s), which by means of the additional data creator, provide an order relationship or prioritization. Together with additional parameters which for example can arise from preferences, and together with the coupling values between the additional data, the order relation can change the data output.

In comparison with concrete document server addresses, terms or category names within the scene term relationship unit are invariant and can reliably and understandably describe the content or a content-related aspect of the data content that is contained within the scene.

In another concrete embodiment, category names, which are contained within the scene term relationship unit, can comprise hierarchical and/or network-like connected named relationships. The category names are terms like generic terms or concretization, which stand in a content-related or meaning-related or relational connection with the category names. The category names can show, display or provide predetermined attribute values or values of features. The category names have a reference, related to meaning of the content, which can be described by means of corresponding or related category name description and metadata.

According to the invention additional data over which a producer or a creator of the name or whose relation can be identified between scene and the category name so that at a use the real producer of this relation can if necessary be compensated for materially and can be contained in the category name. Additionally, data or all data of a producer or creator can be checked, validated, or if necessary, deleted, particularly then, if a damaging behavior by the data producer should be seen or recognized.

Category names or terms can contain in the term table directly one list or set of server addresses with corresponding parameters (for example URLs) whereby these addresses or URLs can comprise additional text, description(s), picture(s), video(s) or executable script(s).

Terms can be taken from a catalog unit. These terms or category names are invariant terms or concepts. Equivalent translations into other languages can be assigned to these category names and be inserted in the corresponding catalog unit as a translation for a term. A multilingual term-based reference system can be created in which to every used term a video scene can be shown. Additionally, creators or editors can extend the catalog of subcategory names and/or of further term relationships between category names within the framework of Open Directory Initiatives.

In another concrete embodiment of the invention, the additional data are visual, acoustic or multi-media data or they are description data or predetermined utilization operations, such as hyperlinks which refer to predetermined server-sided document server units or product databases, which are activated and/or questioned by a user or the additional data are data which are assigned directly to the mentioned data.

In another embodiment, the utilization operations can also be predetermined dynamic script instructions which output data on the client-side and/or display or output these server-sided received data. From the server-side databases or server, further content related terms or additional data, can be requested by means of the digital content signature data or by means of terms or additional data, which are assigned to the signature data. These additional data can subsequently and on the client-side be output or displayed, stores and/or reprocessed by the client-sided data processing unit.

In another embodiment of the invention, the additional data which are delivered by the server, according to the Invention, can be used in the client-sided document visualization/output/representation unit, so that the corresponding content, for instance a scene or a temporal interval, which is in a predetermined timely distance to the requested element will not be output, so that for example within a parental control system, questionable content could be suppressed or skipped in the client-sided output by means of server-sided additional data. In a further concrete embodiment of the invention, the additional data delivered by the server according to the invention, can be transferred, stored and/or managed on a client-sided data storage appliance or unit, so that without further server requests the client-sided stored additional data can be displayed, output, queried, indexed, searched and be reused for a video offline.

In another embodiment of the invention for related, similar and or distributed videos or scenes, new relationships between video data can be created by means of metadata or additional data within the scene additional data relationship unit that without the server, according to the invention, could not been detected or established by the user. Therefore, an identical scene that is contained in different video data can contain a sign that both video data as a whole deal with the same topic and/or with an akin or similar topic. In addition, within the creation of the additional data, this similarity can be used to create an exchange of video file related or assigned data, such as data synchronization of the corresponding metadata or additional data or scene data or the like.

By means of additional data related to the landscape videos of landscapes or vacation spots can be found over the Internet. The assigned videos or video scenes can display hotels or ruins or other vacation destinations. Another advantage of the present invention is based on the circumstances that created by the producer, additional data don't make web pages excessive or unnecessary, but facilitate the surfing between similar web pages for the viewer or the user. Furthermore the invention enables a user of a video to receive content-related web pages and new visitors or viewers would come, by means of server-sided additional data, increased value, to these web pages.

By means of additional data or terms, video data or video scenes can comprise a territorial assignment, such that, for instance, the recording or shooting of videos or of a scene can be found with additional location based data.

In the same manner, pictures, images or videos of objects (works of art) can be found by means of standardized category terms or terminology. In the same manner, training or educational movies, or computer simulations can be supplied and found with keywords.

The values assigned by a producer or creator can also contain an assessment regarding the qualification for children. By means of assigning levels in this manner pictures, images, videos or video fragments, sectors or segments can provide tips or advice on content, which may be corrupting or harmful to youth, such that within the document-visualization/output/representation unit this type of content can be suppressed in the output or provide data such that even the entire web page can be blocked.

The additional data can represent structured descriptions of landscapes or certain objects like buildings or acting persons. These data can be provided to a search engine. This gives someone the opportunity to find the content via the external scene descriptions for movies or videos without knowing that this was specifically intended as such by the Publisher.

Video(s) or picture(s) can therefore be found on the Internet specifically via textual descriptions of portions of content.

These additional data can be assigned on the server-side independently of the real publication or of the original publisher of the video or video scene and it can lead the interested user to the web site of the publisher or to a place of purchase for the document. Supposing these data were stored as additional data on the server, according to the invention, in this manner, with the creation of registered content signatures, further link data and additional, value-added business processes can be tied in.

The metadata or additional data for the video content can contain historical background information or its meaning, thereby providing the interested user or viewer additional information delivery.

The same benefit arises from the subsequent attachment of information to works of art, paintings, movies, architectural buildings or structures, animals, plants, technical objects such as machines, engines, bridges or scientific pictures, images, videos, files, programs or simulations from medicine, astronomy, biology or the like. Also, shown trademark logos within videos can be represented or can be made searchable in the database, according to the invention, by means of the corresponding additional data. As a result, a trademark owner can get information about the distribution of his logos and to the context of usage of the logos.

Furthermore, concrete objects or items such as pictures, images of consumable products or investment goods can very precisely be described with additional data as well, and can be represented in the database according to the invention.

The producer or creator of additional data or the relationships to scenes or of corresponding or related hyperlinks can be participated in or involved in the commercial success via the sale of link data to commercial document servers or by participation in the advertising revenue.

Since the additional data are given to search engines as well, videos or videos scenes can therefore be found more easily on the Internet.

Additionally, for videos, which are in the possession or within access of the user or viewer, additional data can be downloaded from the server onto the local storage unit of the computer, such that subsequent searches can be done independent of remote and of unfamiliar server-sided resources, and such that in an advantageous manner, the protection of privacy within the search can be guaranteed to a larger degree than within an online search.

The preferred Fingerprint method has the attribute, feature or quality such that the result of the application of the fingerprint methods is insensitive with respect to small changes in the picture elements, in particular pixels. This is achieved by the usage of averaging instructions on grey levels in the pixels that are contained in the corresponding areas of the picture. Preferably a method is used that transforms every picture into a standard size—for example 8*8 pixels or 12*12 or 16*16, which is called in the following thumbnail, and which comprises, for every pixel of the thumbnail, a corresponding color or grey levels depth such as 8 bits, 12 bits or 16 bits for every pixel contained in the thumbnail. In the transformation of the original picture onto the thumbnail, each pixel of the thumbnail corresponds to an area of the original image. By the use of mathematical methods the color error can be reduced (and its impact can be made insignificant). After the transformation into grey levels, an average grey level value can be calculated from this area by averaging over all corresponding (relevant) pixels. In addition, rules can guarantee that pixel on the border or edges are taken only into account with the corresponding fraction of their value. With this averaging, the influence of some or a few pixels is negligible. As soon as the methods for the creation of these fingerprints are standardized, these fingerprint data can also be created or produced on the client-side and be searched in the database. Possible methods to find and search fingerprints within a database consist in the repeated application of averaging (of grey values) over areas within the fingerprints in order to get data of a length, which is indexable in the database. The indexing method is variable and can be adapted by means of optimization to the size of the database.

### TABLE OF REFERENCES

The following table contains additional descriptions of the references to FIGS. 1 and 2, and it is part of the present invention and its disclosure.

Reference descriptions are:

| | |
|---|---|
| (5) | Electronic data processing unit |
| (10) | Video data unit (video or video data table) |
| (10a) | Video data, which are managed by the video data unit (10) |
| (15) | Video frame unit (video frame table) |
| (15a) | Video frame data, which are managed by the video frame unit |
| | (15) |
| (20) | Scene data unit (scene table) |
| (20a) | Scene data, which are managed by the scene data unit (20) |
| (25) | Term data unit (term table) |
| (25a) | Term data, which are managed by the term data unit (25) |
| (30) | Link data unit (link data table) |
| (30a) | Link data, which are managed by the link data unit (30) |
| (50) | Video data image relationship unit (M:N table, intermediate |
| | table) |
| (55) | Image scene relationship unit (M:N table, intermediate table) |
| (60) | Scene term relationship unit (M:N table, intermediate table) |
| (65) | Term link data relationship unit (M:N table, intermediate |
| | table) |
| (70) | Video term relationship unit (M:N table, Intermediate table) |
| (75) | Function unit via which different units are operating together |
| | or communicating with each other |
| (80) | Data interface of the video frame identification unit |
| (85) | Providing, provisioning or supply unit |
| (90) | Request unit |
| (95) | Output unit or output device |
| (110) | Video equivalence (table) |
| (120) | Scene profile(s) |
| (125) | Term profile(s) |
| (130) | Link data profile(s) |
| (a) | Usage of the request unit (90), in order to use the video frame |
| | identification unit (80) |
| (b) | Transfer or transmit data by means of a data interface to the |
| | video frame identification unit (80) of the video frame unit |
| | (15) |
| (c) | Reference/link by means of a foreign key within the video |
| | image/frame relationship unit to the video frame unit |
| | (table) |
| (d) | Reference/link by means of a foreign key within the video |
| | image/frame relationship unit to the video equivalence unit |
| | (table) |
| (e) | Reference/link by means of a foreign key within the video |
| | image/frame relationship unit to the video frame unit |
| | (table) |
| (f) | Reference/link by means of a foreign key within the image- |
| | scene relationship unit to the video fame unit (table) |
| (g) | Reference/link by means of a foreign key within the |
| | image scene relationship unit to the scene unit (table) |
| (h) | Reference/link by means of a foreign key within the scene |
| | term relationship unit to the scene unit (table) |
| (i) | Reference/link by means of a foreign key within the scene |
| | term relationship unit to the scene profile(s) |
| (j) | Reference/link by means of a foreign key within the scene |
| | term relationship unit to the term unit (table) |
| (k) | Reference/link by means of a foreign key within the scene |
| | term relationship unit to the term profile(s) |
| (l) | Reference/link by means of a foreign key within the term |
| | link data relationship unit to the term unit (table) |
| (m) | Reference/link by means of a foreign key within the term |
| | link data relationship unit to the term Profile(s) |
| (n) | Reference/link by means of a foreign key within the term |
| | link data relationship unit to the link data unit (table) |
| (o) | Reference/link by means of a foreign key within the term |
| | link data relationship unit to the link data profile(s) |
| (p) | Reference/link by means of a foreign key within the video |
| | data term relationship unit to the video frame unit |
| | (table) |
| (q) | Reference/link by means of a foreign key within the video |
| | data term relationship unit to the video equivalence unit (table) |
| (r) | Reference/link by means of a foreign key within the video |
| | data term relationship unit to the Term unit (table) |
| (s) | Reference/link by means of a foreign key within the video |
| | data term relationship unit to the term profile(s) |
| (t) | Interconnection or interoperation of the function unit with |
| | the video data image relationship unit |
| (u) | Interconnection or interoperation of the function unit with |
| | the video data term relationship unit |
| (v) | Interconnection or interoperation of the function unit with |
| | the image scene relationship unit |
| (w) | Interconnection or interoperation of the function unit with |
| | the scene term relationship unit |
| (x) | Interconnection or interoperation of the function unit with |
| | the term link data relationship unit |
| (y) | Transferring or transmitting of the results of the data |
| | request to the providing, provisioning or supply unit |
| (z) | Request of the results from the output unit (95) |
| (S10) | Process step for the usage of the request unit (90) for |
| | the extraction or assignment of data to a video and/or |
| | to a video frame and transferring it to server |
| (S20) | Process step for the usage of the identification means |
| | for the extraction of data, so that a video frame can be |
| | identified and/or can be found in a table |
| (S30) | Process step for the extraction von reference data in the |
| | video frame unit, which is used to assign the extracted |
| | and/or selected video frame which is assigned in partic- |
| | ular unambiguous but not necessarily unambiguous |
| (S40) | Process step for the selection or extraction von scene- |
| | dependent reference values from the image Scene relation- |
| | ship unit (55) by means of the video frame reference data |
| (S50) | Process step for the selection or extraction von term- |
| | dependent reference values from the scene term relation- |
| | ship unit (60) by means of the scene reference data |
| (S60) | Process step for the selection or extraction von link |
| | data-dependent reference values from the term link data |
| | relationship unit (65) by means of the term reference |
| | data |
| (S70) | Process step for the providing, provisioning or supplying |
| | of all or selected amount of reference data which are as- |
| | signed to scene data and/or term data and/or link data in |
| | the providing, provisioning or supply unit (85) by means |
| | of extraction of additional data from the scene unit |
| | (20), from the term unit (25) and from the Link data unit |
| | (30), |
| (S80) | Process step for the transmission or broadcasting of ad- |
| | ditional data to the visualization, output or representa- |
| | tion unit |
| (S90) | Process step for the visualization, output or representa- |
| | tion of data to an output unit (95), which enables user(s) |
| | to view or to receive additional data to a video |

1. Device for the assignment, query, request, providing, management and assignment of, in particular via the Internet transferred or received external data related to picture element data, which consist of a plurality of video frames, in segmented video data of at least one scene, with
a first assignment, classification or correlation unit, which is suitable for assigning of a plurality of video frames to a scene and for producing or creating of corresponding first assignment, classification or correlation data,
a second assignment, classification or correlation unit, which is suitable for assigning of at least one identification data element to the scene and for producing or creating corresponding second first assignment, classification or correlation data,
a third assignment, classification or correlation unit, which is suitable for assigning of a, the external data identifying, connection data element of the identification data element and for producing or creating corresponding third first assignment, classification or correlation data,
and a request unit that is usable by a user, which is designed in a manner that the user by means of a selection device selects a picture element data from one video frame and by evaluating the first, second and third first assignment, classification or correlation data is suitable for providing the user access to the picture element data that is corresponding to the external data.
